(19) United States
(12) Patent Application Publication
(10) Pub. No.: US 2005/0171807 A1
(43) Pub. Date: Aug. 4, 2005

(54) Transaction processing engine

(75) Inventors: Moshe Klein, Woodland Hills, CA (US); Alon Shwartz, Woodland Hills, CA (US); Jim Zafrani, Woodland Hills, CA (US)

Correspondence Address: MARVIN H. KLEINBERG/KLEINBERG & LERNER, LLP, Suite 1080, 2049 Century Park East, Los Angeles, CA, 90067, US

(73) Assignee: Synthean, Inc.

(21) Appl. No.: 11/044,952

(22) Filed: Jan. 31, 2005

Related U.S. Application Data
(63) Continuation-in-part of application No. 10/898,464, filed on Jul. 23, 2004.
(60) Provisional application No. 60/540,960, filed on Jan. 30, 2004.
(60) Provisional application No. 60/540,961, filed on Jan. 30, 2004.
(60) Provisional application No. 60/540,964, filed on Jan. 30, 2004.
(60) Provisional application No. 60/540,959, filed on Jan. 30, 2004.
(60) Provisional application No. 60/540,962, filed on Jan. 30, 2004.

(51) Int. Cl. G06F 17/60

(52) U.S. Cl. 705/1

(57) ABSTRACT

A method and apparatus for determining when the final event in an instance of a business activity has occurred, correlating each event with the instance of a business activity, creating evaluative data based upon each event and each instance of a business activity and saving the data associated with each instance of a business activity.

This application claims priority as a continuation in part of the provisional patent applications: Checkpoint Processing Engine, Ser. No. 60/540,959 filed Jan. 30, 2004; Event Capture Engine, Ser. No. 60/540,961 filed Jan. 30, 2004; Information Provider Engine, Ser. No. 60/540,960 filed Jan. 30, 2004; Business Activity Architect, Ser. No. 60/540,964 filed Jan. 30, 2004; Transaction Processing Engine, Ser. No. 60/540,962 filed Jan. 30, 2004 and the non-provisional patent application Universal Transaction Identifier Ser. No. 10/898,464 filed Jul. 23, 2004.

### BACKGROUND

1. Field of the Invention

The present invention relates to business processes, and more specifically to a system for correlating the data generated in a series of events within an instance of a business activity with that instance of a business activity.

2. Background of the Invention

Businesses operate via business activities, which are complex composites of sub- or micro-processes logically connected in the context of a common objective. For example, for a user of an internet website who is ordering a product, several different and distinct processes take place that all relate to the single transaction of purchasing the product. A web server delivers web pages with the requested content to the user. A database server provides some of the content. A credit card verification server ensures that payment is validated. A shipping server might take care of automating the shipping process. Finally, an inventory server could decrement the inventory list for the item demonstrating that one has been purchased. Any number of other servers and networked interactions can take place in effecting a single transaction.

In the prior art, the tracking of a single instance of a business activity has been relatively difficult. Capturing the data associated with each step in an instance of a business activity has been even more difficult. In prior art solutions, a single unique transaction identifier has been required to be passed from each server to server or process to process along the way to the completion of the entire instance of the business activity. Alternatively, an event within an instance of a business activity would be evaluated by going to the server or process that failed and receiving a single report from that server or process. For example, if a credit card server failed to properly process a charge to a customer, the only report of what occurred would exist in the records of the credit card server itself. This problem is only exacerbated when multiple instances of business activities fail at a particular server or process or several servers or processes and the business needs timely information in order to address these issues efficiently and effectively.

It is therefore an object of the present invention to provide a means by which each event and each event or checkpoint and all associated event data used in the event may be associated with a particular instance of a business activity. It is another objective of the present invention to provide a means by which an instance of a business activity may be monitored through multiple events. It is a further object of this invention to calculate and provide metrics for evaluating each business activity and instance of a business activity. These and other objectives of the present invention will become apparent from the following description of the invention.

### SUMMARY OF THE INVENTION

A method and apparatus for determining when the final event in an instance of a business activity has occurred, correlating each event with the instance of a business activity, creating evaluative data based upon each event and each instance of a business activity and saving the data associated with each instance of a business activity.

### BRIEF DESCRIPTION OF THE DRAWINGS

FIG. 1 is a block diagram showing the elements of a computer system which can be used to implement the present invention.

FIG. 2 illustrates the elements of a sample IT infrastructure that may be used by a business enterprise.

FIG. 3 illustrates the various systems used in a representative business activity using the sample IT infrastructure.

FIG. 4 is a series of checkpoints in an example business activity using the elements in FIG. 3.

FIG. 5 is an example of the elements that may be included in a transaction that may be in each event monitored by this process.

FIG. 6 is a depiction of the information technology infrastructure from FIG. 3 along with example event data that may be included in each element.

FIG. 7 is a flow-chart depicting the steps in the applying the transaction processing engine to the completion of an event.

FIG. 8 is a depiction of a series of checkpoint performance thresholds.

FIG. 9 is a depiction of a series of checkpoint functional thresholds.

### DETAILED DESCRIPTION OF THE INVENTION

The present invention provides a method, implemented on a computer system, for identifying a business event, extracting business data from that event for later correlation of that data to a specific instance of a business activity. In the following description, specific method steps and procedures are described in order to give a more thorough understanding of the present invention. In other instances, well known elements such as the computer's operating system and specific software functions are not described in detail so as not to obscure the present invention unnecessarily.

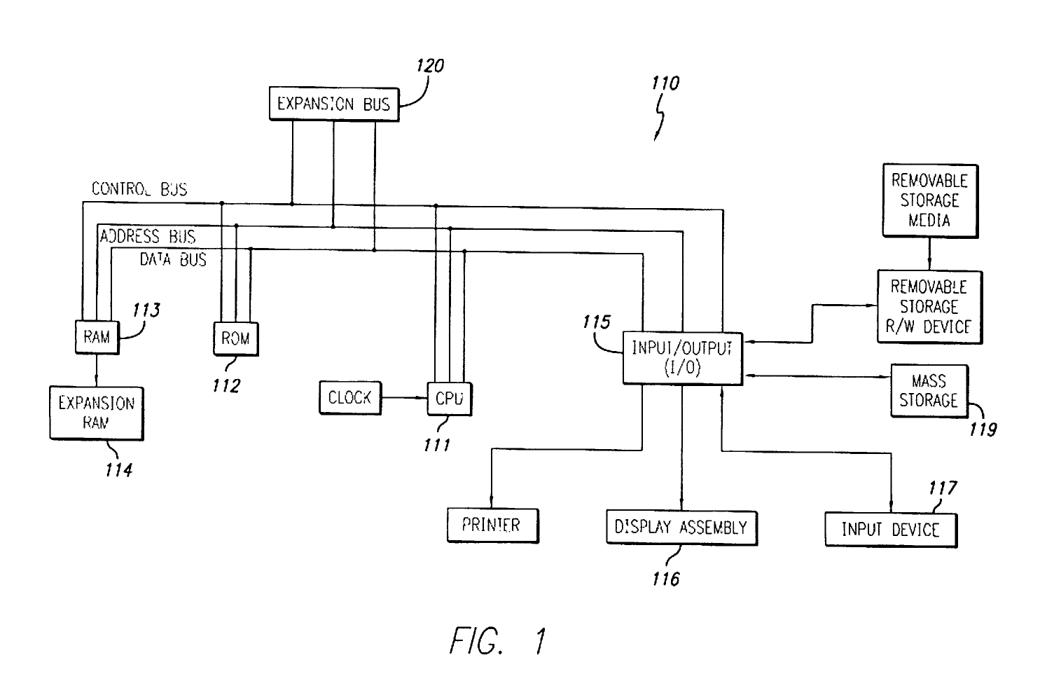

Referring first to FIG. 1, a block diagram of a general purpose computer system which may be used to implement the method of the present invention is illustrated. Specifically, FIG. 1 shows a general purpose computer system 110 for use in practicing the present invention. As shown in FIG. 1, computer system 110 includes a central processing unit (CPU) 111, read-only memory (ROM) 112, random access memory (RAM) 113, expansion RAM 114, input/output (I/O) circuitry 115, display assembly 116, input device 117, and expansion bus 120. The computer system 110 may also optionally include a mass storage unit 119 such as a disk drive unit or nonvolatile memory such as flash memory and a real-time clock 121.

Some type of mass storage 119 generally is considered desirable. However, mass storage 119 can be eliminated by providing a sufficient mount of RAM 113 and expansion RAM 114 to store user application programs and data. In that case, RAMs 113 and 114 can optionally be provided with a backup battery to prevent the loss of data even when computer system 110 is turned off. However, it is generally desirable to have some type of long term mass storage 119 such as a commercially available hard disk drive, nonvolatile memory such as flash memory, battery backed RAM, PC-data cards, or the like. The controlled vocabulary data which is stored in the present invention will be generally stored on mass storage device 119.

In operation, information is input into the computer system 110 by typing on a keyboard, manipulating a mouse or trackball, or “writing” on a tablet or on a position-sensing screen of display assembly 116. CPU 111 then processes the data under control of an operating system and an application program, such as a program to perform steps of the inventive method described above, stored in ROM 112 and/or RAM 113. CPU 111 then typically produces data which is output to the display assembly 116 to produce appropriate images on its screen.

Suitable computers for use in implementing the present invention are well known in the art and may be obtained from various vendors. The preferred embodiment of the present invention is intended to be implemented on a personal computer system, web server or other business application server. Various other types of computers, however, may be used depending upon the size and complexity of the required tasks. Suitable computers include mainframe computers, multiprocessor computers and workstations.

The present invention can be utilized to enable a business enterprise to examine business activities in a more efficient and cost-effective manner. The term “business activity” as used herein refers to a logically related series of processes or functions that are performed by the business enterprise in combination to achieve a desired goal. For example, a business activity can be as simple as taking an order from a customer, and delivering a product in response. On the other hand a business activity can be as complex as all of the functions performed by a network of servers performing various functions in the completion of an online order for a product.

An “instance” of a business activity is all of the operations performed in completing one instance of the business activity. For example, as described above the business activity could be taking an order online and delivering a product. An instance of that business activity could be one individual's order for a specific product processed from start to finish including all of the processes in between. A business activity is the general case, whereas an instance of a business activity is the specific case. The business activity includes all of the processes necessary to complete one business activity in the general, whereas an instance of a business activity is each of those processes performed in one specific instance. In the case of the financial advisor example, the business activity would be advising the client and all of the functions and processes necessary to reach that objective. The instance of the business activity would be advising a specific client, using those functions and processes toward the goal of advising a specific client. Another instance of that business activity would be the advising of a different client, and so on. Alternatively, an instance of a business activity may also be called a transaction. One transaction could be the purchase of the product online, whereas the business activity would be the general definition of the processes and functions necessary to purchase a product online.

A “checkpoint” or “event” is a single step in the completion of an instance of a business activity. An example of a checkpoint could be the step in the purchase of a product over the internet, where the IT infrastructure of the business attempts to charge the specified amount to the customer. The attempt to charge the card would be a checkpoint. A successful charge made to the card would be another checkpoint. A timeout, no response from the credit card server for a specified period of time, would be a failed checkpoint. A typical timeout for a charge to a user's credit card could be as short as thirty seconds or as long as five minutes, depending upon the implementation.

Checkpoints are defined business activity-wide. So, for example, the process of charging the card, start to finish, would be one complete checkpoint definition. Each checkpoint is a single step in the process, but checkpoint definitions do not have meaning outside of other checkpoints, such as the request for the credit card charge only has meaning as a completed checkpoint once the successful charge is made or the credit card is declined or there is a timeout of the operation. At that point, the checkpoint has meaning in relation to other checkpoints in the process. This means that for each business activity there are several related checkpoint definitions. For the process of completing an order using the Internet, example checkpoints could be web server access request, web server access response, requesting a product be put into an online shopping cart, putting a product into an online shopping cart, attempting to charge the credit card for a specified amount, receiving a response to that credit card charge request, passing the request to ship along to a shipping department and actually shipping the product. Many other checkpoints in that business activity could also be included. Checkpoints are only completed (successful) or not-completed (failed) in instances of a business activity. A business activity is the abstract “definition” of each instance of a business activity. Thus in the abstract placing an order online, a checkpoint is only completed or not completed in the actual placing of a specific order.

“Event data” or “data” as used herein refers to data used or processed in the process of completing or attempting to complete a checkpoint. This data could be an individual's name, address and credit card number. This data could also be an internet protocol address for a user's computer or the server itself. Any data that the user of the checkpoint processing engine desires to log may be included in the “event data” that is created.

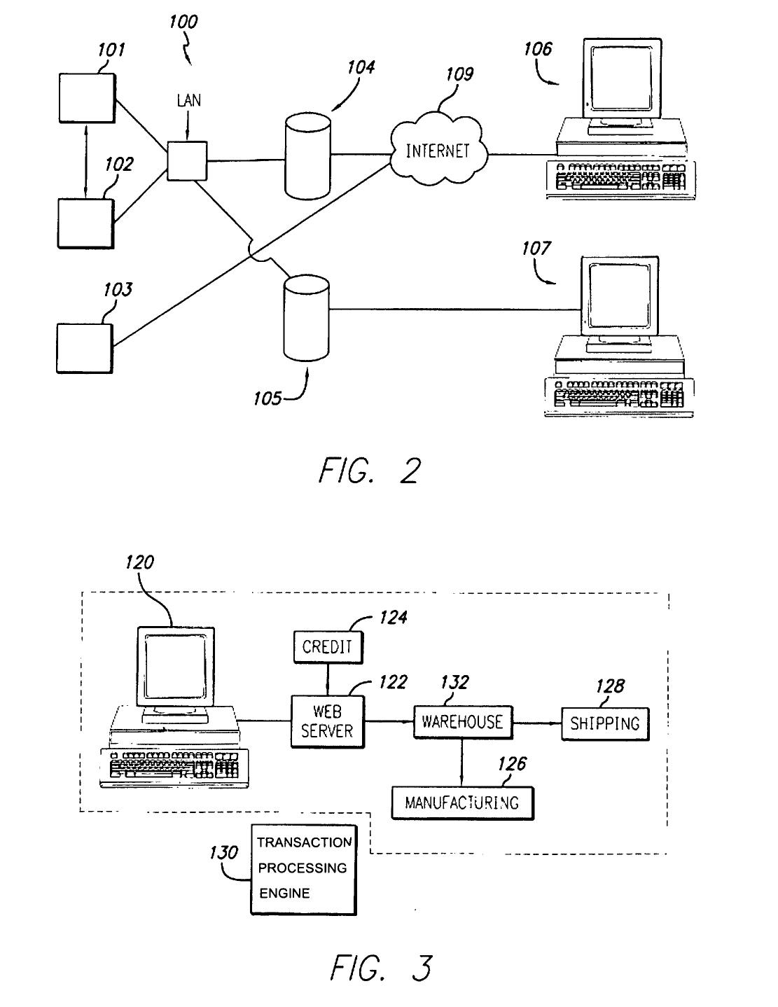

Many modern business activities are executed using a complex series of computers which make up an IT infrastructure. Referring next to FIG. 2, a representation of an example IT infrastructure 100 used by a business to complete a business activity is illustrated. The infrastructure may include a number of computer servers 101, 102, 103 which execute various functions or steps in a business activity. Although only three computer servers are illustrated in FIG. 2, it will be understood that a larger number of servers may be present in the infrastructure as required by the complexity of the business activity. The infrastructure may also include one or more databases 104, 105 for the storage and retrieval of data. Also Internet web servers 106, 107 may also be employed. Various other servers may also be included within an IT infrastructure.

Referring next to FIG. 3 a representative business activity is shown, including the elements on which that business activity is performed. The elements used in this example information technology infrastructure are a personal computer 120, a credit card processing server 124, a web server 122, a warehouse processing server 132, a shipping server 128, and a manufacturing server 126. The manufacturing server will likely be outside of, for example, any retailer's infrastructure, but communication will likely, take place between the company's infrastructure and the outside manufacturer's.

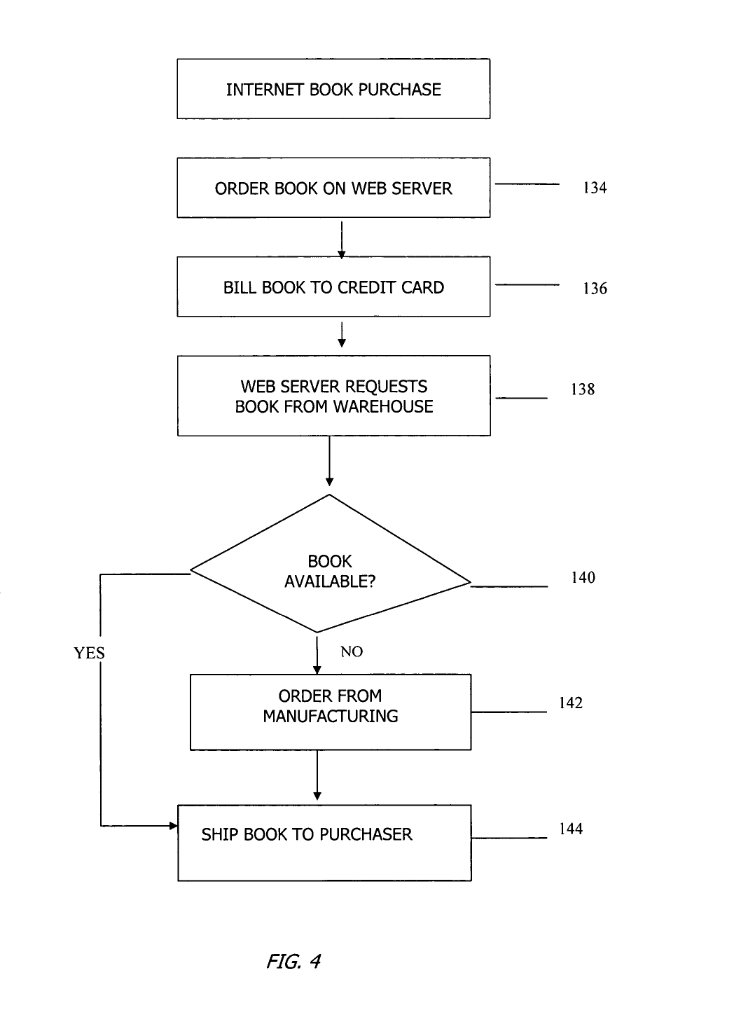

Referring to FIGS. 3 and 4, an example transaction is depicted. In this transaction, the user may place an order for a book 134 using her home computer 120 and using the web server 122. This order would include various data about the transaction including the user's name, address, credit card number, quality of product desired and any number of other data. Because this order is placed for this book using a credit card, the credit server 124 processes that card and bill the user's account 136. The web server 122, then passes data on to the warehouse processing server 132 in step 138, such as the item number, the person's name and address ordering the product. The warehouse server 132 determines if any of that book are available 140 and, if not, contacts the server of the publisher or manufacturer 126 of the book to place an order 142. Once the book is available, the warehouse server 132, then contacts its shipping server 128, sending name and address along for mailing purposes which ships the book to the purchaser 144.

Along the way, each step of this transaction passes data in various forms back and forth across a network. This is a very simple example. In any large-scale online retailing infrastructure, there are multiple web servers, accounting servers, database servers, order processing servers, data storage servers, and the like. Many times, entire clusters or clusters of clusters of servers are used to perform various functions in the online process. In industries other than online retailing, the servers may simply be web servers, file transfer protocol servers, virtual private network gateway servers, and internet portal servers that also pass similar data back and forth.

These examples make it easier to demonstrate that during this process, data is constantly being passed back and forth between the servers. This data is very rarely and almost never in the same or similar format. More recently efforts have been made to use a standard interface format between machines to aid in usability across different software platforms, but in many instances this is not available or simply impossible given the type of tasks being performed. One example of such an effort is the increasing use of extended markup language.

Referring again to FIG. 3, the transaction processing engine 130 runs on an additional server responsible for listening to receive information from the co-pending patent application entitled Checkpoint Processing Engine with Ser. No. 60/540,959. The transaction processing engine 130 may stand alone on its own server or be included on a single server along with several other related data processing applications involved in business activity monitoring. The transaction processing engine 130 waits to receive data from each checkpoint in every instance of a business activity. Referring again to the prior example, as the book is purchased, data is sent from the purchaser's home computer to the web server over the Internet. This data is processed by the co-pending patent application entitled Checkpoint Processing Engine with Ser. No. 60/540,959. Once the checkpoint data has been processed and formatted appropriately, the transaction processing engine 130 receives the data and begins correlating that event with a particular instance of a business activity or transaction.

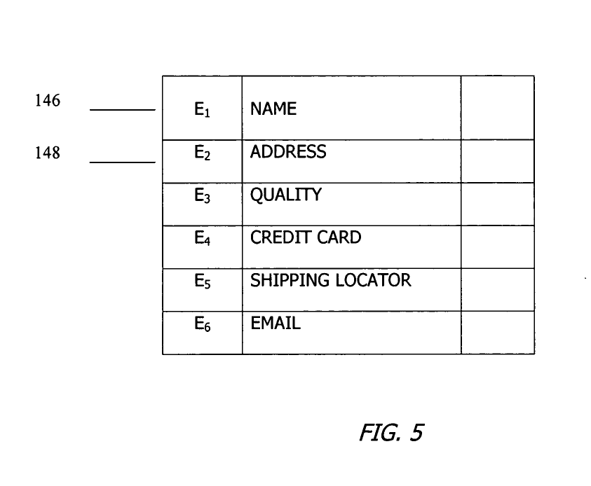

Referring next to FIG. 5, an example of the data that may be passed back and forth among various elements of the information technology infrastructure during a complete instance of a business activity is depicted. Depicted in element 146 is name. In element 148 is address. At each step along the way, all of the data will almost certainly never be sent at once or in an easily identifiable format. As this data is captured by the Checkpoint Processing Engine, it is passed along to the transaction processing engine 130.

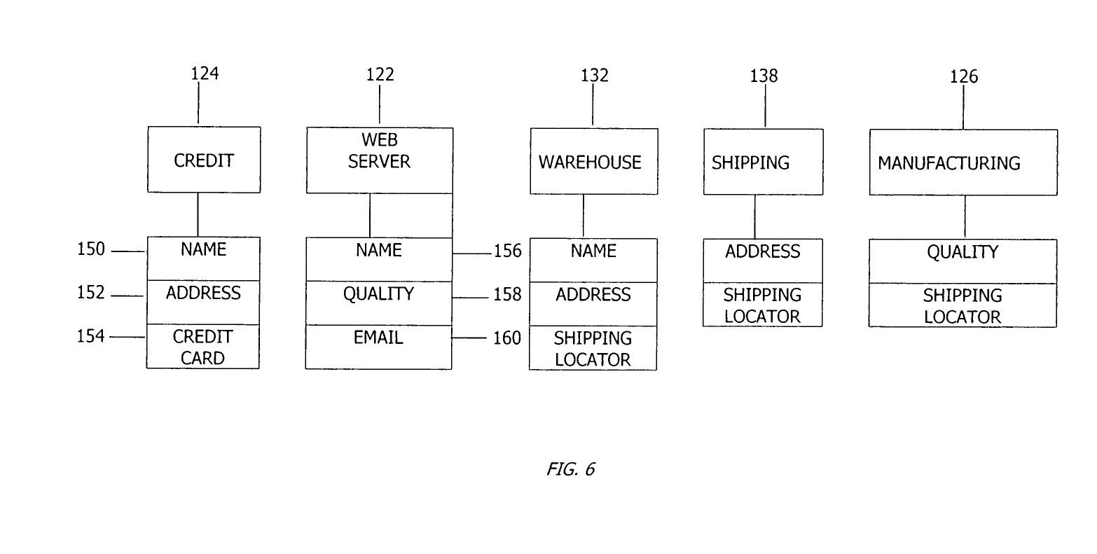

Referring now to FIG. 6, each of the information technology infrastructure elements depicted in FIG. 3 are included, along with the pieces of information each element gives or receives during a communication. For example, the credit card processing server 124 gives and receives the name 150, the address 152 and the credit card number 154. In this example, the credit card processing server 124 receives or transmits no other data elements. The web server 122, receives or transmits the name 156, a quality requirement of the product 158 and the email 160 of the purchaser. Therefore, no single portion of the infrastructure has access to a complete listing of data elements, as depicted in FIG. 5.

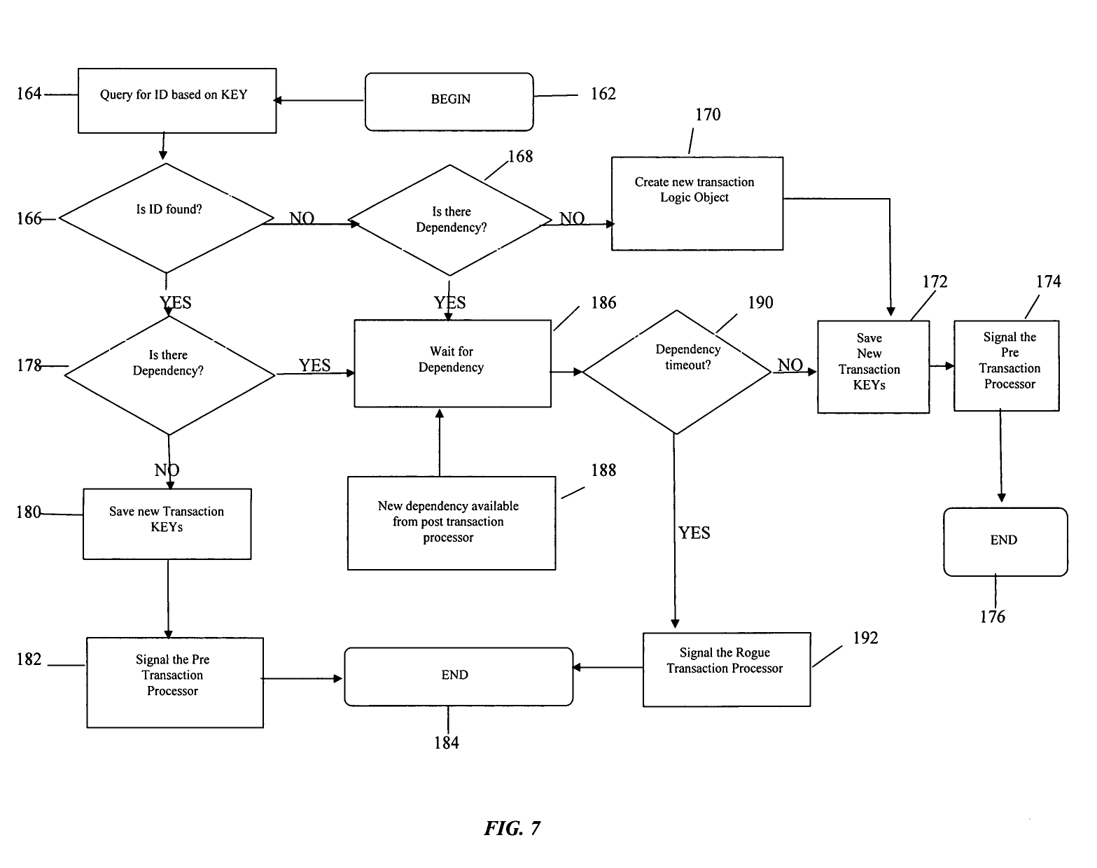

Referring now to FIG. 7, a flow-chart depicting the way in which the preferred embodiment of the transaction processing engine 130 works is depicted. Other embodiments may alter the order of the steps, add or take away steps. In the first step of the preferred embodiment, a properly formatted event data is passed along to the transaction processing engine 130 in step 162. In the preferred embodiment, the second step is to query the current listing of keys to determine if a currently pending instance of a business activity already has an ID based upon completed checkpoints in this transaction in step 164. The transaction processing engine 130 keeps track of the currently unclosed transactions and gives them “keys.” These keys are used to quickly find the currently-pending transactions that are missing a “checkpoint six.” The keys also contain all current data concerning the completed checkpoints and any other related data, such as processing-related information. Using the data included in the checkpoint that has been received and the Universal Transaction Identifier described in currently pending patent application Ser. No. 10/898,464 filed Jul. 23, 2004 the transaction processing engine attempts to correlate a particular checkpoint in a transaction with another checkpoint in that transaction. So, for example, if the transaction processing engine has already created a universal transaction identifier for the order being placed on the website and it receives data from the credit card server that, using the universal transaction identifier, it correlates to that order being placed, then it will “link” those two checkpoints or events as being part of a single transaction or instance of a business activity.

The transaction processing engine then checks to see if there is an ID based upon the key of the checkpoint. The ID as used herein refers to the universal transaction identifier. The key refers to the type of checkpoint that is received by the transaction processing engine. So, for example, if the transaction processing engine receives data from a web server request checkpoint having been completed, it checks to see, using the fact that it is a “web server request” checkpoint, whether there is a pending transaction using the universal transaction identifier. The first step, in the preferred embodiment, is to see if there is a universal transaction identifier in step 166. It may not be found—it has not been created. In either event, universal transaction identifier found or not found, the transaction processing engine checks to see if there is a dependency for that type of checkpoint. In step 168, the checkpoint is evaluated without a universal transaction identifier having been created. In step 178, a universal transaction identifier has already been created. If the universal transaction identifier has not been created, then in step 170 a new universal transaction identifier and related logic object is created including all of the necessary attributes of that type of transaction, such as the number and type of checkpoints involved in completing that type of transaction (if known) and any dependency and ordering of the checkpoints.

The new universal transaction identifier is simply a number to which each of the individual checkpoints will be correlated and saved as being a part of one transaction. The related logic object will contain all of the information about the types of data, the order of checkpoints, any dependencies between the checkpoints and any other relevant information about the instance of a business activity. So, for example, the universal transaction identifier could be 3459630254 in the preferred embodiment. It may be any unique means of identifying a particular group of checkpoints. The logic object associated with a particular universal transaction identifier may contain information signaling that this type of transaction contains fourteen steps, steps three and five are dependant upon step one, and that the process ends once a completed step twelve or fourteen has been received.

In step 178, the transaction processing engine checks to see if there is any dependency in this transaction on a later checkpoint being completed. This dependency means that to complete checkpoint C, data from checkpoint A and from checkpoint B must be combined and both have been completed. For example, in order to ship a product, a company may require that the order be placed and that the credit card transaction have cleared before allowing the ship to take place. In this case, the completion of the ordering process would end checkpoint A, the credit card transaction processing completion would be the end of checkpoint B. Once those two process were complete and only once they were complete, checkpoint C, the shipping of the product may take place. Dependency need not be two checkpoints before a third checkpoint. It may be as simple as one checkpoint before another single checkpoint or as complex as any number of checkpoints taking place before one or many checkpoints taking place. Any permutation of these would be a dependency situation.

In step 178, if there is a dependency, then the transaction processing engine determines whether it should, based on the type of checkpoint data just received, wait for a dependency in step 186. It may also trigger a dependency or be made aware of a dependency mid-transaction by the checkpoint processing engine in step 188. This will warn the transaction processing engine, once a dependency is detected by the checkpoint processing engine, that a dependency exists, so that a particular step in a transaction will not timeout prematurely because it was waiting on a as-of-yet unfinished checkpoint several steps later upon which the current checkpoint is dependent.

In step 178 if there is no dependency, then in the preferred embodiment the newly received checkpoint and checkpoint data are saved to the transaction key in step 180. This may involve the creation of a new transaction key of one has not been created or may simply involve amending the previously created transaction key. Once the data is saved for that checkpoint the pre-transaction processor is signaled in step 182 to continue waiting for additional checkpoints and checkpoint data to correlate.

The dependency wait procedure enables the complete transaction to end, if necessary, while waiting an appropriate amount of time for each step from the first checkpoint in the transaction to the last checkpoint. In the preferred embodiment of the transaction processing engine then waits for a dependency timeout in step 190. In other embodiments, there may be not allowance for timeouts. Also, in other embodiments, there may be no consideration of dependency at all. In an alternative embodiment, each checkpoint may be logged and recorded, and transactions only closed after a timeout or not closed at all unless the final checkpoint is reached.

If there is a dependency timeout, then the transaction processor signals the rogue transaction processor in step 192. This processor is responsible for dealing with transactions that are incomplete due to timeouts mid-transaction with dependencies. These unfinished transactions are the most useful in evaluating where transactions are failing. The rogue transaction processor is only signaled in the event that a transaction checkpoint experienced a timeout on a dependent checkpoint. This rogue transaction processor then determines if the timeout is critical, that is, the instance of the business activity or transaction cannot complete without this dependency having been completed. If so, it ends the transaction in step 184. If not, it then may perform some recovery of the transaction, activate a corrective or action script or notify the server administrator. It will then continue waiting for the next checkpoint and checkpoint data set that will follow in the event of this particular timeout based upon its “knowledge” of the type of transaction being processed.

If there is no dependency timeout and the event upon which the current checkpoint is dependant successfully completes, then in the preferred embodiment, the transaction processing engine saves the transaction keys, that is it saves each of the completed transaction checkpoints that have been completed in step 172. The transaction processing engine then begins the pre-transaction processor in step 174. The pre-transaction processor then waits for the next completed checkpoint to be passed to transaction processing engine.

Once the final checkpoint has been received, the transaction with a particular universal transaction identifier is closed. The transaction processing engine “knows” that the final checkpoint in a transaction (or instance of a business activity) has occurred when a “final step” checkpoint has completed and once that final step checkpoint has been successfully correlated to a particular transaction using the universal transaction identifier. The final step for a particular transaction may be reached by way of a timeout, such as at step 190, with no other checkpoints pending. Alternatively, there may be a timeout with a known dependency, such that if step five along the eight step process has a timeout, then the transaction will not be able to complete and the transaction has effectively ended at that point. Once the final step is reached or there is a critical timeout in the operation, the transaction is closed in the final step 176 or 184.

In the preferred embodiment, this process is completed for each instance of a business activity. This could be thousands or hundreds of thousands of transactions in a day. This process would be completed for each transaction on an Internet store. Every transaction would be given a unique universal transaction identifier, each checkpoint would be monitored and incorporated into the “whole transaction” by the transaction processing engine, and failures in checkpoints would also be retained for later review.

Once at least one instance of a business activity has occurred, the transaction processing engine will have access to large amounts of transaction and checkpoint related data. In the preferred embodiment of the invention, it can then be used compute numerous metrics to track the efficiency and availability of the business activity. Numerous other metrics may be created that are not presented here, but these metrics have proven to be the most useful and are included in the preferred embodiment of the invention.

The first metric computed is called a performance threshold for an instance of a business activity. This is a flexible metric, based upon user specifications, that provides a measurement of the elapsed time of a transaction. In the preferred embodiment, the user may specify the threshold of “good,” “fair” and “poor.” This may be in days, hours, mintues, seconds and milliseconds in the preferred embodiment for each of these three tiers. Good may be, for example, ten minutes, to process a complete order for an online product. Fair may be from ten to twenty minutes for the same transaction and anything over twenty minutes may be a poor transaction performance threshold. This same metric may be calculated based on the average performance or for a subset of this type of business activity. So for example, this metric may be calculated for the average time to complete an online order for a product.

In the preferred embodiment, another metric that is calculated is the transaction functional threshold. This metric uses the number of failed checkpoints in a particular transaction as a measure of the completeness of a transaction. Again, the user may define the number of failed checkpoints that correspond to “good,” “fair” and “poor” respectively. More than three thresholds may be defined, but in the preferred embodiment, only three are provided. A failure of a single checkpoint may be “poor” for one type of business activity but may still be well in the “good” range of another type of business activity. The user may specify any range for each categorization. The same metrics may also be computed for an average or for a subset of a set of instances of a particular business activity.

In the preferred embodiment, a transaction availability performance threshold is also calculated. This is a metric based upon the prior two metrics that is a percentage measure of availability for a particular type of business activity. The user may set a percentages for “good,” “fair” and “poor” for a particular type of business activity. The transaction processing engine then uses the equation:
100×(number of completed transactions with “good” transaction performance/number of completed transactions)
This provides a metric to gauge the availability of a particular type of business activity as a percentage. This threshold is also user determinable. For example, for a particular type of transaction an 85% availability may be “good,” while for another type of transaction only 98% or better will be “good.” This metric may be calculated for each type of business activity, an average of one business activity or for a subset of a type of business activities (such as all online orders on last Tuesday).

Transaction integrity threshold is also calculated in the preferred embodiment of the invention. This metric gauges the integrity of the business activity definition and of server integrity. If there is a particularly low percentage in this calculation, it may mean that the business activity checkpoints themselves are poorly defined, thus resulting in lots of critical timeouts or missed or missing checkpoints. It also may mean that the server upon which a particular checkpoint is being run is particularly overloaded, thus resulting in numerous timeouts or long-open transactions. This is essentially a measure of the completed and otherwise finished transactions (excluding critical timeouts) in comparison to the number of total transactions. The transaction processing engine then uses the equation:
100×(number of completed transactions with “no issues”/number of completed transactions)
No issues is defined as a transaction that completes normally, times out, but the timeout was not critical or currently open transactions. A percentage is set by the user as being “good,” “fair” or “poor.” There may be additional categories, but in the preferred embodiment there are only three. For a particular business activity, a 95% transaction integrity may be “good,” while for another activity, a 75% transaction integrity may be “good.” This metric may be calculated for each type of business activity, an average of one business activity or for a subset of a type of business activities (such as all online orders on last Thursday).

In the preferred embodiment, the checkpoint performance threshold is also calculated. This is a measure of a single transaction's or group of transactions' (using average in the group case) performance based on the time between checkpoints. Again, the user may establish threshold times in days, hours, minutes, seconds or milliseconds in the preferred embodiment. These times are used as a measure of “good,” “fair” or “poor.” Thirty-one milliseconds between two checkpoints in a particular transaction may be “good,” while in another transaction three minutes or several hours may still be “good.” The bases for “good,” “fair” and “poor” are all based upon user needs.

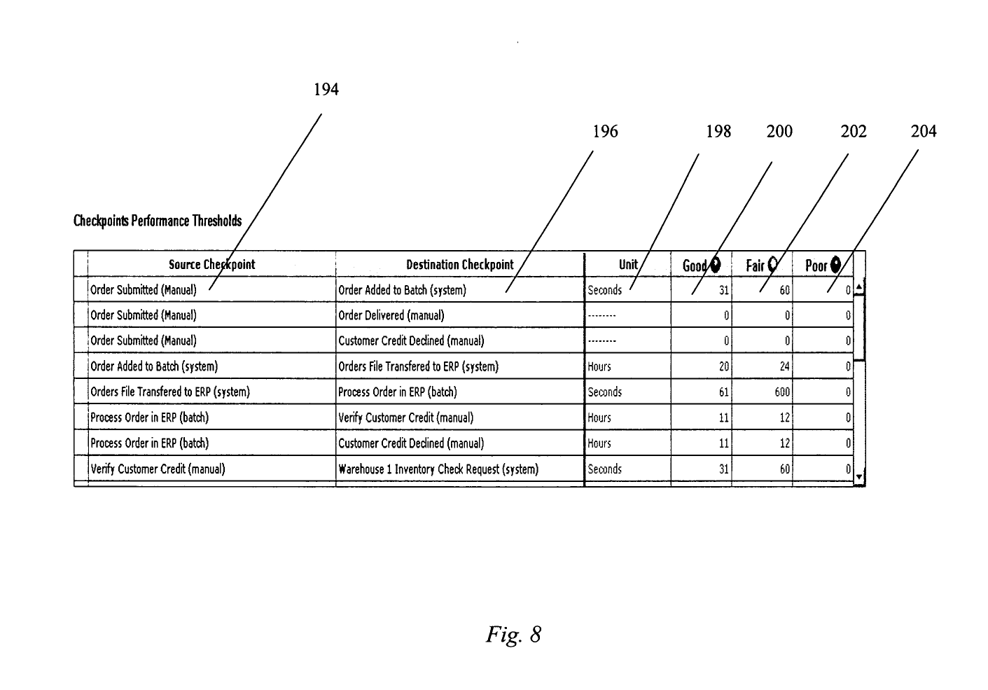

Referring now to FIG. 8, a series of checkpoint performance thresholds are depicted. For the time between the order submitted in element 194 and the order added to batch in element 196 the units are in seconds as depicted in element 198.

The “good” threshold is set at 31 seconds and lower. The “fair” threshold is set at 60 seconds down to 31 seconds in element 202. The “poor” is set at zero seconds or undefined in element 204. These types of performance thresholds can be set for each checkpoint along the way to a complete business activity.

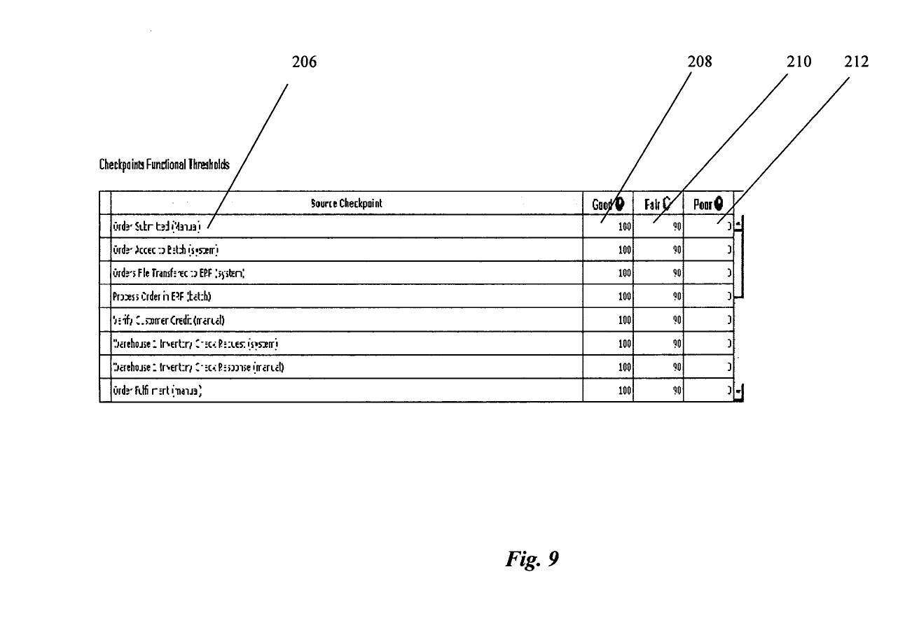

In the preferred embodiment, the checkpoint functional threshold is also calculated. This is a measure of a group of transaction's percentage of good checkpoint performance as compared to total number of checkpoints. The equation for this metric is:
100×(number of “good” checkpoint performance checkpoints /number of completed checkpoints of that type)
Referring now to FIG. 9, a group of example checkpoints functional thresholds are depicted. The first, in element 206 is the checkpoint which starts at order submitted. For that checkpoint, the current “good” threshold is 100 as depicted in element 208. The “fair” threshold in element 210 is 90. Finally, the “poor” threshold is set at zero which is undefined in element 212. This metric would calculate a percentage of time between two checkpoints that was within the “good” threshold. Then, this would also return a “good,” “fair” or “poor” ranking for that checkpoint, such as the order submitted checkpoint in element 206.

Each of these metrics are used to evaluate the performance and functional availability of the various checkpoints and business activities. Other metrics may be calculated, but these are the calculations included in the preferred embodiment of the invention.

Accordingly, a checkpoint processing engine has been described. It is to be understood that the foregoing description has been made with respect to specific embodiments thereof for illustrative purposes only. The overall spirit and scope of the present invention is limited only by the following claims, as defined in the foregoing description.

1. A method of monitoring a business activity comprising the steps of:
determining when at least one checkpoint in an instance of a business activity has completed;
receiving said at least one checkpoint and the data associated with said at least one checkpoint;
correlating said at least one checkpoint with said instance of a business activity; and
storing said at least one checkpoint and correlated data associated with said at least one checkpoint as a part of said instance of a business activity.

2. A digital computer system programmed to perform the steps specified in the method of claim 1.

3. Computer-readable media containing programming designed to accomplish the method of claim 1.

4. The method of claim 1, further comprising the additional step of providing analysis of said at least one checkpoint.

5. The method of claim 1, further comprising the additional step of providing analysis of said instance of a business activity.

6. The method of claim 1, further comprising the additional step of aggregating said correlated data associated with at least one checkpoint.

7. The method of claim 1, further comprising the additional step of aggregating a group of said instances of at least one business activity.

8. The method of claim 6, further comprising the additional step of providing analysis of said at least one checkpoint.

9. The method of claim 6, further comprising the additional step of providing analysis of said group of said instances of at least one business activity.

10. The method of claim 8, wherein said analysis is a checkpoint performance threshold.

11. The method of claim 8, wherein said analysis is a checkpoint functional threshold.

12. The method of claim 9, wherein said analysis is a transaction performance threshold.

13. The method of claim 9, wherein said analysis is a transaction functional threshold.

14. The method of claim 9, wherein said analysis is a transaction availability performance threshold.

15. The method of claim 9, wherein said analysis is a transaction availability functional threshold.

16. The method of claim 9, wherein said analysis is a transaction integrity threshold.

17. A method of monitoring a business activity comprising the steps of:
determining when at least one checkpoint in an instance of a business activity has completed;
correlating said at least one checkpoint with said instance of a business activity;
storing correlated data associated with said at least one checkpoint as a part of said instance of a business activity;
providing analysis of said at least one checkpoint; and
providing analysis of at least one of said instance of a business activity.

18. A digital computer system programmed to perform the steps specified in the method of claim 17.

19. Computer-readable media containing programming designed to accomplish the method of claim 17.

20. A computer-based apparatus for monitoring a business activity comprising:
processing means for determining when at least one checkpoint in an instance of a business activity has completed;
reception means connected to said processing means for receiving said at least one completed checkpoint;
correlation means connected to said reception means for correlating at least one completed checkpoint with said instance of a business activity; and
storing mans connected to said correlation means for storing correlated data associated with said at least one checkpoint as a part of said instance of a business activity.

21. The computer-based apparatus of claim 20, further comprised of analytical means connected to said storing means for analyzing said at least one completed checkpoint.

22. The computer-based apparatus of claim 20, further comprised of analytical means connected to said storing means for analyzing at least one of said instances of a business activity.
